(19) United States
(12) Patent Application Publication
(10) Pub. No.: US 2005/0198821 A1
(43) Pub. Date: Sep. 15, 2005

(54) Machining tool and method for repair of rotor teeth in a generator

(75) Inventors: Christopher J. Reville, Greenfield Center, NY (US); Richard Bever, Delanson, NY (US)

Correspondence Address: NIXON & VANDERHYE P.C., 901 NORTH GLEBE ROAD, 11TH FLOOR, ARLINGTON, VA, 22203, US

(73) Assignee: General Electric Company, Schenectady, NY (US)

(21) Appl. No.: 11/031,019

(22) Filed: Jan. 10, 2005

Related U.S. Application Data
(60) Provisional application No. 60/551,352, filed on Mar. 10, 2004.

(51) Int. Cl. E21B 7/24; B23C 1/20

(52) U.S. Cl. 29/889.1; 409/178; 409/201

(57) ABSTRACT

A machine cutter including a cutting bit positionable in a slot of a machine; a drive shaft rotatably driving the bit; a bracket having a plurality of angular positions for supporting and pivoting the bit wherein bit pivots about a pivot point on the bracket proximate to the bit, and a frame supporting the bracket on a slidable support providing linear movement to the bit.

### RELATED APPLICATION

This application claims the benefit of U.S. Provisional Patent Application Ser. No. 60/551,352, filed on Mar. 10, 2004, and incorporates by reference the entirety of that provisional application.

### BACKGROUND OF THE INVENTION

This invention relates generally to the repair of cracks in teeth of an industrial rotary machine and machining tools for making such repairs. In particular, the invention relates to cutting machines which when mounted on a rotor facilitate relief cutting of rotor teeth to remove cracks in the teeth.

Large industrial power generators, such as those that are driven by steam gas turbines, have rotors with longitudinal slots that receive conductive winding coils. The slots are cut lengthwise into the surface of the cylindrical rotor. Rows of slots are arranged around the poles of the rotor. The teeth of the rotor are the metal fingers between the slot rows. The teeth typically extend the length of the rotor, and are parallel to each other and to the rotor axis. The sides of adjacent teeth form the slots. In cross-section, each slot has a dovetail profile near the rotor surface and a rectangular profile radially inward of the dovetail. Conductive coils are stacked in the rectangular portion of the slots.

Wedges are inserted above the coils and into the dovetail section of the slots. The sides of the wedges abut against the sides of the pair of adjacent rotor teeth that define the slot in which the wedge is inserted. The wedges are aligned end-to-end in each slot. They secure the underlying coils in the slot. The wedges in some slots are formed of a hard metal, such as steel, which wears against the sides of the rotor teeth. The wedges in other slots are formed of a soft metal, such as aluminum.

During long term operation of the generator (such as during decades of operation), the dovetail surfaces on rotor teeth may crack due wear of the wedges abutting against the teeth. Cracks tend to form in teeth that have slots that had been capped with hard metal wedges. Cracks are most likely to form on the upper surfaces of the dovetail section of the a rotor tooth. The cracks typically occur in the dovetail surfaces adjacent to an end-to-end joint of wedges.

If not repaired, small cracks in a rotor tooth may propagate circumferentially through the tooth and to an adjacent slot. Rotors are periodically inspected, such as every five, ten or twenty year, to determine if cracks have formed in their teeth. The inspection of the rotor requires the generator to be taken offline, the rotor removed from the stator and the retaining rings removed from the ends of the rotor. A crack detection probe, e.g., an eddy current probe, is passed over the surface of the rotor. If cracks are detected in a slot, the wedges and windings are removed from the slot to expose the sides of the teeth and the crack.

Repair of cracks in rotor teeth is done by a machinist that machines metal out of the surface of the rotor tooth to remove the crack and smooth the tooth surface surrounding the crack. Prior techniques for machining rotor teeth to remove cracks have required labor intensive machining operations that may require the rotor to be offline for over a dozen of days. Such long offline periods are extremely expensive in lost power generation production. There is a long felt need for techniques to assist machinist in repairing cracks in rotating machines, and to reduce the number of days needed to repair the cracks in a rotor.

### BRIEF DESCRIPTION OF THE INVENTION

The invention may be embodied as a machine tool comprising: a cutting bit positionable in a slot; a drive shaft rotatably driving the bit; a bracket having a plurality of angular positions for supporting the drive shaft and bit, wherein the shaft and bit are pivotable attached to the bracket at a pivot point proximate to the bit, and a frame supporting the bracket on a slidable support, said slidable support providing movement to the bit in a direction in a plan common to a pivoting plane of the bit.

The invention may include a machine cutting tool comprising: a cutting bit positionable in a slot of a machine; a bracket having a plurality of angular positions for supporting and pivoting the bit, wherein bit pivots about a pivot point on the bracket proximate to the bit, and a frame supporting the bracket on a slidable support providing linear movement to the bit in a plane parallel a pivoting plane of the bit.

The invention may be embodied as machine cutting tool comprising: a cutting bit positionable in a slot; a drive shaft rotatably driving the bit; a cutting assembly slidably supports the bit and drive shaft such that the bit moves reciprocally with respect to the assembly; a bracket supporting the cutting assembly at a plurality of angular positions, wherein cutting assembly pivots with respect to the bracket about a pivot point proximate to the bit, and a frame supporting the bracket wherein the frame is slidably attached to the bracket.

The invention may also be embodied as a machine tool that is mounted in a rotor slot and is capable of performing four relief cuts on the sides of the slot from a single tool position. In particular, the machine tool includes a frame having in-line gripping feet that latch to the sides of a rotor slot to position a cutting bit adjacent a crack in the teeth that define the slot. The tool allows the cutting bit to move axially, transversely across the slot and pivot to make two radial and two oblique cuts in the surfaces of the teeth on either side of the slot.

The invention may be also embodied as a method for machining a crack in a slot defined by opposite teeth, said method comprising: mounting a cutter in said slot such that the cutter is axially aligned with the slot; aligning a cutting bit of the cutter with a section of the opposite teeth to be machined; aligning the cutting bit with a radial line of the slot; moving the cutting bit along a linear path transverse to a slot axis to engage a first tooth of the opposite teeth; machining a radial relief cut in said first tooth; moving the cutting bit along said linear path to a second sooth of the opposite teeth; machining a second radial relief cut in said second tooth; pivoting the cutting bit in a plane parallel to the linear path to a first oblique angle; moving the cutting bit along said linear path to the first tooth; machining a first oblique relief cut in said first tooth; pivoting the cutting bit in said plane to a second oblique angle; moving the cutting bit along said linear path to the second tooth, and machining a second oblique relief cut in said second tooth.

### BRIEF DESCRIPTION OF THE DRAWINGS

FIG. 1 is an enlarged cross-sectional view of a rotor showing a portion of a rotor tooth, slot, winding and wedge.

FIG. 2 is a perspective side view of a dovetail section a rotor tooth.

FIG. 3 is an enlarged perspective side view of a dovetail section of a rotor tooth with a wedge (shown in cross-section) adjacent the tooth.

FIG. 4 is schematic side view of a first tooth machining device, showing features of the device some of which would be otherwise hidden from an outside view.

FIG. 5 is a schematic top view of the tooth machining device.

FIGS. 6, 7 and 8 are schematic front views of the tooth machining device showing the cutting jig in left tilt, center and right tilt positions, respectively.

FIG. 9 is a schematic diagram showing a partial cross-section of a rotor having dovetail slots and a rotor tooth cutting frame having two cutting heads mounted thereon, which is an alternative embodiment to a rotor tooth cutting machine to that shown in FIGS. 4 to 8.

### DETAILED DESCRIPTION OF THE INVENTION

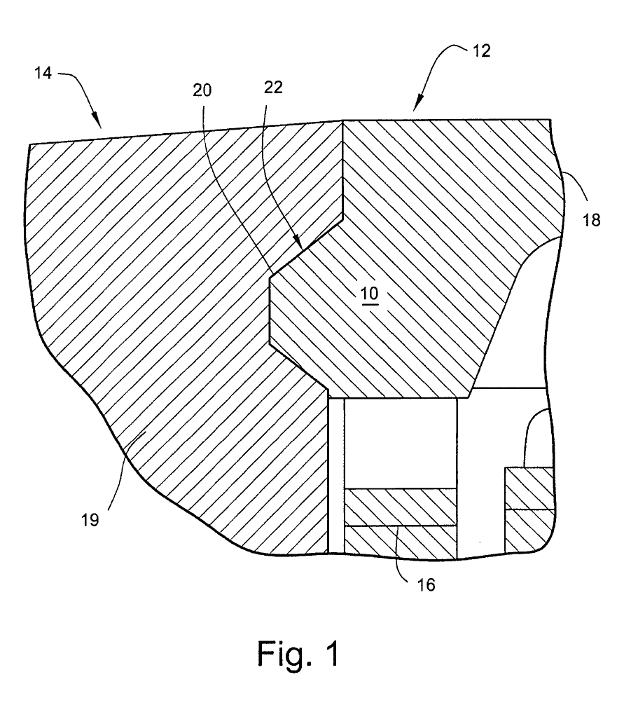

FIG. 1 is an enlarged cross-sectional view of the dovetail section 10 of a rotor slot 12 that is cut radially inward along the longitudinal length of a rotor 14. Conductive windings 16 are mounted in the rotor slot 12. A wedge 18 caps the winding in the slot and mounts in the slot at the dovetail section 10. The wedge 18 has extended side surfaces that engage the rotor slot surfaces at the dovetail sections 20. The metal row between adjacent slots are the teeth 19 of rotor. The side surfaces of the teeth define the slots. The dovetail surfaces 20 of the rotor teeth tend to be heavily loaded by centrifugal and vibration forces because wedges 18 abut against the dovetail surfaces 20 of the teeth 19.

Over the course of many years of rotational operation of a power generator, the vibration and forces acting between the wedge and the rotor teeth can induce cracks in the dovetail sections 20 of the teeth. In particular, inspection of certain rotors which have been in continuous operation for decades identified approximately a third of rotors as having cracks in the dovetail section of certain teeth. The cracks can be detected by periodic, e.g., every decade, inspection of the rotor using devices such as eddy current probes. To inspect the rotor for cracks, it is necessary to remove the rotor from the generator and remove the retaining ring from the rotor. When a crack is detected, the wedges (and possibly the coil windings) are removed from at least those slots in which a crack has been detected and may be removed from all slots in a rotor. Cracks tend to form on the dovetail tooth upper surface 22 which is an upper surface of the dovetail surface 20 of the tooth. If the propagation of the crack is sufficiently shallow in the tooth surface, the crack can be removed by machining away a small portion of the rotor tooth at the dovetail surface where the crack is located. The machining removes the crack and smoothes the surface of the tooth in the area surrounding the crack.

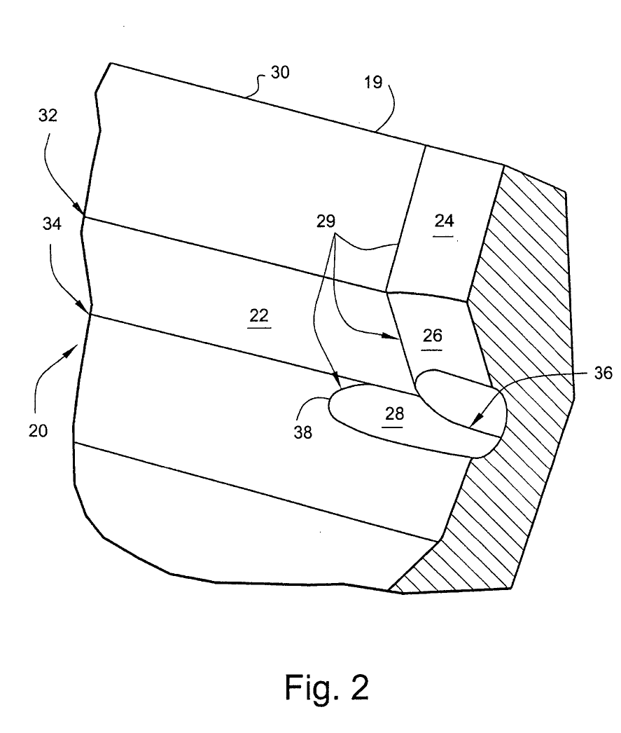

FIG. 2 is a side perspective view of the side surfaces of a rotor tooth 19 and, in particular, the dovetail section 10 of the tooth. The upper dovetail surfaces 22 tend to be the surfaces where cracks occur. A series of three relief cuts 24, 26 and 28 are made into the tooth surface to remove a crack. Radially relief cut 24 extends radially from the top surface 30 of the rotor, along the radial upper side surface of the tooth and to the top edge 32 of the dovetail section 20 of the tooth. The relief cut is semi-cylindrical in shape and has a depth corresponding to or greater than the depth of the crack being removed. The width and depth of the relief cut 24 may be selected by the machinist removing the crack.

An oblique relief cut 26 is machined in the upper dovetail surface 22 from the top edge 32 of the dovetail to the outer corner 34 of the dovetail. The oblique relief cut is radially aligned with the radial relief cut 24 and extends along the width of the upper dovetail surface 22 of the tooth, where cracks most likely form. The oblique relief cut may be at an angle of 45 degrees with respect to a radial line through the rotor axis. The width and depth of the oblique relief cut 26 is often substantially the same as the width and depth of the radial relief cut 24. However, the width and depth of the three relief cuts 24, 26 and 28 may vary somewhat depending on the type of crack to be removed and the machine cut settings selected by the operator. The cross-sectional shape of the relief cuts 24, 26 tend to be a shallow semi-circular cut that provides smooth surfaces on the slot wall. Moreover, the outer edges 29 of the radial cuts may be feathered to avoid sharp transitions between the uncut surfaces of the slot and the relief cut.

The lateral relief cut 28 is oblique to the radial end and oblique relief cuts 24 and 26. The lateral relief cut 28 is at the outer dovetail corner 34. The lateral relief cut extends laterally from either side of the oblique relief cut and is parallel to an axis of the rotor. The length of the lateral relief cut 28 is selected by the machinist and depends on the depth and extent of the crack. The lateral relief cut may have its greatest depth at its center 36 and become gradually shallower towards the opposite ends 38 of the lateral relief cut. The center 36 of the lateral relief cut is radially aligned with the radial relief cut and oblique relief cut. The width of the lateral relief cut may have a semi-cylindrical groove shape similar to the shapes of the radial and oblique relief cuts.

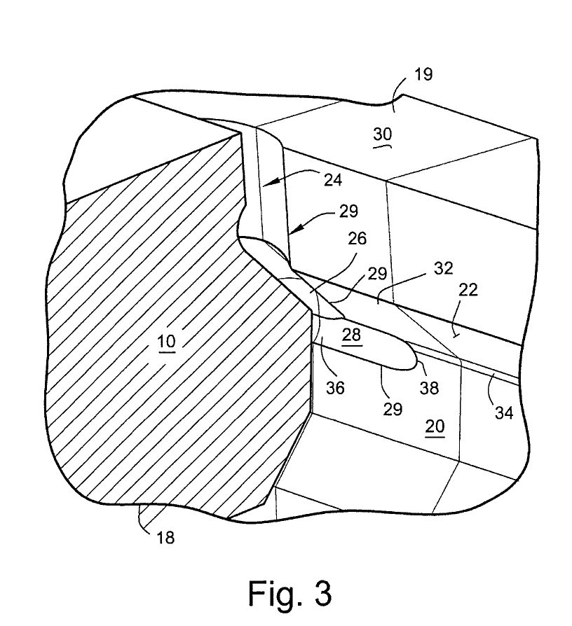

FIG. 3 is a perspective view of the sides of a rotor tooth and particularly the dovetail section 10 of the tooth. In addition, a cross-section of a wedge 18 is shown inserted into the slot defined by the side surfaces of the tooth. The radial relief cut 24, oblique relief cut 26 and lateral relief cut 28 are shown in conjunction with the wedge 18 to show the interface between the relief cuts and the wedge. The series of three relief cuts 24, 26 and 28 may be made on both of opposite sides of the adjacent teeth that define the slot. The opposite sets of three relief cuts are made in both sides of the same slot and at the same lateral location along the slot.

The relief cuts 24, 26 and 28 provide stress relief on the surfaces of the dovetail section 20 of the tooth 19 where a crack had previously formed. Because of the relief cuts, the wedge 18 applies substantially less vibrational and centrifugal forces to the surface 22 of the dovetail where the crack had previously formed.

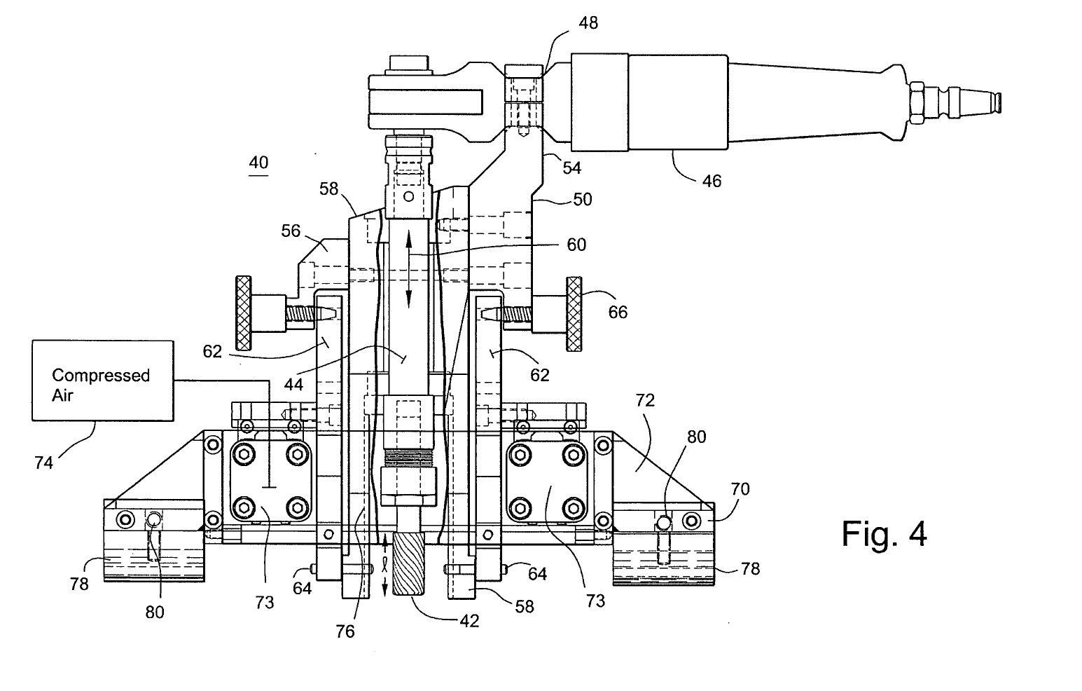

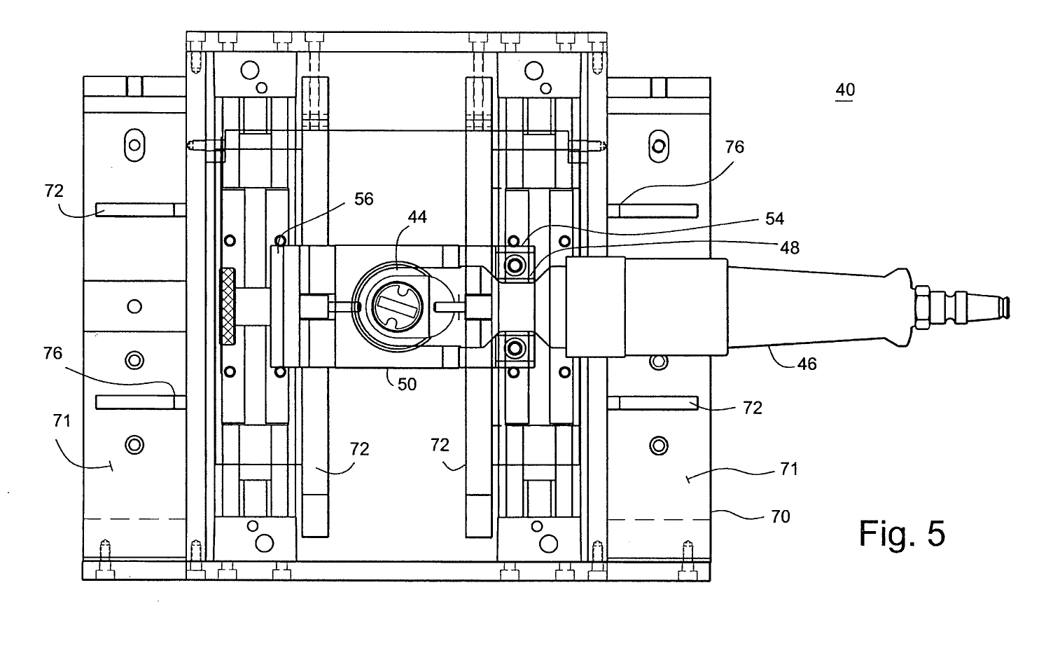

FIG. 4 is a side view of a rotor tooth machine cutter 40. FIG. 5 is a top view of the cutter 40. The tooth cutter 40 comprises a rotating cutting bit 42 that includes helical cutting surfaces for machining the rotor tooth. The cutting bit is replaceable and the type of bit is selected by the machinist. The length (l) of the cutting bit 42 is sufficient to extend the length of the desired radially and oblique relief cut. The tool cutter 40 is adapted to perform the radial and oblique relief cuts. The tool cutter 40 does not perform the a lateral relief cut. The cutting bit 42 is detachably mounted to a shaft 44 that extends radially upwards to a drive motor 46. The drive motor 46 may be driven pneumatically and actuated manually by a machinist grasps the handle of the drive motor. The drive motor fits into a collar 48 on a bracket 50 of the cutter. The bracket 50 supports the motor 46 and drive shaft 44. The bracket 50 includes a first arm 54 that extends radially outward and includes the collar 48 and includes a base 56 that is rectangular in top view. The bracket 50 supports a drive shaft housing 58 that is a column extending around the drive shaft 44 and down to the cutting bit 42. The drive shaft column 58 includes an aperture coaxial with and to receive the drive shaft 44. The drive shaft 44 moves reciprocally along the path shown in arrow 60 to provide reciprocal movement of the drive shaft and bit 42 along the axis of the drive shaft 44 and as indicated by arrow 60.

The motor bracket 52 and drive shaft housing 58 are attached to fan shaped support brackets 62. The fan support brackets 62 support the cutting assembly 52 of cutting bit 42, drive shaft 44, drive motor 46, motor bracket and drive shaft housing 58. The fan support brackets 62 enables the cutting assembly 52 to pivot about pivot point 64 which is perpendicular and aligned with the cutting bit 42. The pivot point 64 allows the cutting bit to be pivoted about its center point so as to allow the cutting angle to be changed without substantially translating the position of the cutting bit. The pivot point 64 may be slightly offset from the center point of the cutting bit depending on the reciprocal position of the cutting bit along its axis. The pair of support brackets 62 are arranged on opposite sides of the cutting assembly 52.

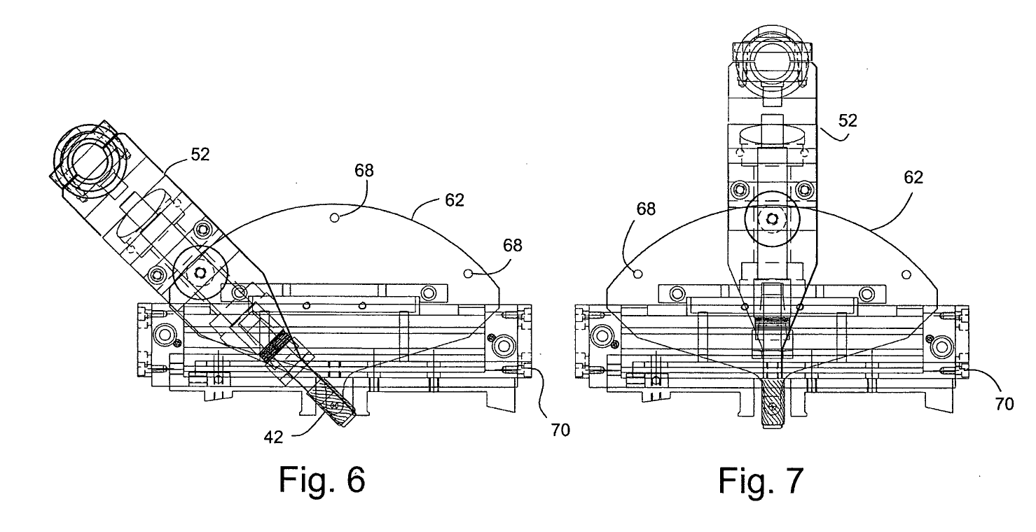

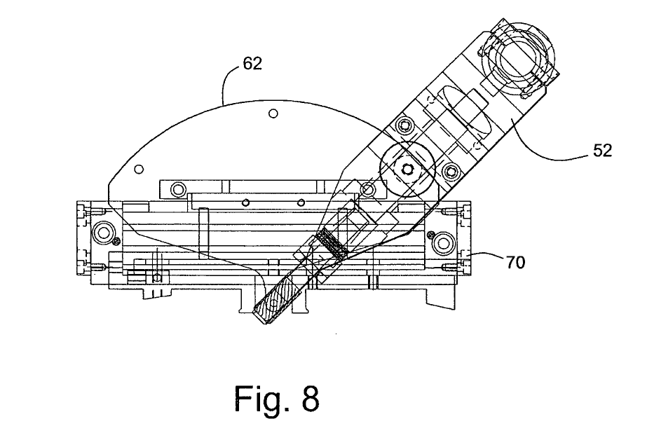

The pivot position of the cutting bit 42 is set by thumb screws 66 which engage recesses 68 (see FIGS. 6 to 8) on the fan support bracket 62. The recesses 68 are arranged at angular positions on the bracket 62 corresponding to the cutting angle for the radial and oblique relief cuts to be performed on the two surfaces. For example, a recess 68 may be at a 90° angle which is in radial alignment with the rotor axis. In addition, there may be recesses 68 arranged at oblique angles of 45° so as to tilt the bit 42 to make the oblique relief cut. The number and angular position of the recesses 68 may be determined based on the radial and oblique relief cuts intended to be made in the tooth surface.

The fan support bracket 62 is fixed to a jig base 70. The jig base positions the cutting assembly 52 and fan brackets 62 and particularly the cutting bit 42 within a slot of the rotor such that cutting bit 42 are axially aligned with the slot. The jig base 70 includes a frame 71 that supports a pair of opposite fan support brackets 62 on a sliding rail 72. The rails 72 allows the cutting assembly 52, and including the cutting bit 42, to slide transversally from one side of a rotor slot to the opposite side. This transverse movement of the cutting bit 42 allows the bit to engage and cut opposite tooth. The cutter tool 40 is able to make two radial relief cuts and two oblique cuts while the base 70 is at one position in the slot.

The side to side transverse movement of the cutting bit 42 across a rotor slot and the reciprocal movement of the cutting bit 42 along its axis 60 may be manually adjusted by the machinist and automated by pneumatic valves 73. The pneumatic valves 73 are coupled to a source of compressed air 74. The pneumatic valves when activated apply a uniform force to the transverse movement of the cutting bit 42 and/or the axial movement 60 of the cutting bit. The transverse and/or axial movement of the cutting bit is selected by the machinist performing the machining operation. The pneumatic valves allow the actual cutting of the rotor teeth to be performed automatically moving the cutting bit as it engages the rotor teeth. Mechanical hard stops 76 that limit the transverse movement of the cutting bit 42 and/or the axial movement of the cutting bit. These stops are adjustable and set by the machinist in order to control the depth at which the cutting bit 42 cuts into the tooth. By adjusting the stops 76, the machinist can set the depth of the relief cuts to be made to the rotor tooth.

The jig base 70 includes feet 78 that fit into the slot of a rotor. The feet are laterally spaced from the cutting bit 42 by several inches. The feet spread apart and walk into the slot of the rotor. The outer surfaces of the feet 78 may have a dovetail surface which fits into the dovetail surfaces of the opposite teeth of the slot. These feet may spread apart by manual operation of a spreading device 80. Once the feet are spread apart, the jig foot 70 is locked into the rotor slot such that the jig is aligned with the longitudinal axis of the slot. The feet securely hold the jig base and hence the cutting assembly 52 in the slot during machining operations.

In operation, the machinist manually inserts the tooth cutter 40 into the slot such that the bit 42 is adjacent the crack to be repaired. The feet 78 are spread apart to secure the jig foot 70 to the slot. With the cutting bit 42 aligned with the crack in the tooth to be removed, the cutting bit is placed in a radial position with respect to the fan plate 62 so as to perform the radial relief cut. The cutting bit 42 is rotated by the motor 46 and then brought into cutting contact to the tooth by activating the pneumatic valves 73. The cutting bit 42 may be moved by transverse movement across the slot to the rotor tooth and/or by axial movement along the axis 60 of the drive shaft.

After the radial relief cut is performed on one tooth, the cutting bit 42 is slid transversely across the slot along rails 72 to cut a radial relief cut in the opposite tooth. The depth of the radial relief cuts in the two opposite teeth are determined by the position of the hard stops 76 as set by the machinist.

Once the radial relief cuts are completed, the machinist pivots the cutting bit 42 by turning the thumb screw 66 and positioning the cutting assembly 52 at a 45 degree angle and setting the thumb screw in an appropriate recess 68 on the fan support bracket 62. Once the cutting head is aligned obliquely with the surface of the tooth to be machined, the pneumatic valves 73 are activated and the cutting bit is moved automatically into cutting position against the tooth until the hard stops 76 are reached by the cutting bit at which point the cutting stops. Once the first oblique relief cut is made in the side of one tooth, the machinist repositions the alignment jig 50 such that the cutting bit 42 is repositioned to an opposite 45 degree angle for cutting the tooth on the opposite side of the slot. The jig 50 is repositioned by turning the thumb screw 66 and pivoting the jig 50 about the fan support bracket 62.

The tooth cutter 40 provides a cutting mechanism for performing radial relief cuts and oblique relief cuts in both teeth on opposite sides of a rotor slot. The cutter ensures that the cutting bit 42 is positioned properly within the slot and against the teeth surfaces so as to perform the four related radial and oblique cuts on opposite teeth in an accurate and expedited manner. The cutter 40 allows several sets of relief cuts to be performed along the slot of a rotor by repositioning the feet 78 at different positions in the slot corresponding to cracks in the teeth. The tooth cutter 40 is sufficiently mobile that it may be carried manually by a machinist to the rotor and positioned in those slots which require machining.

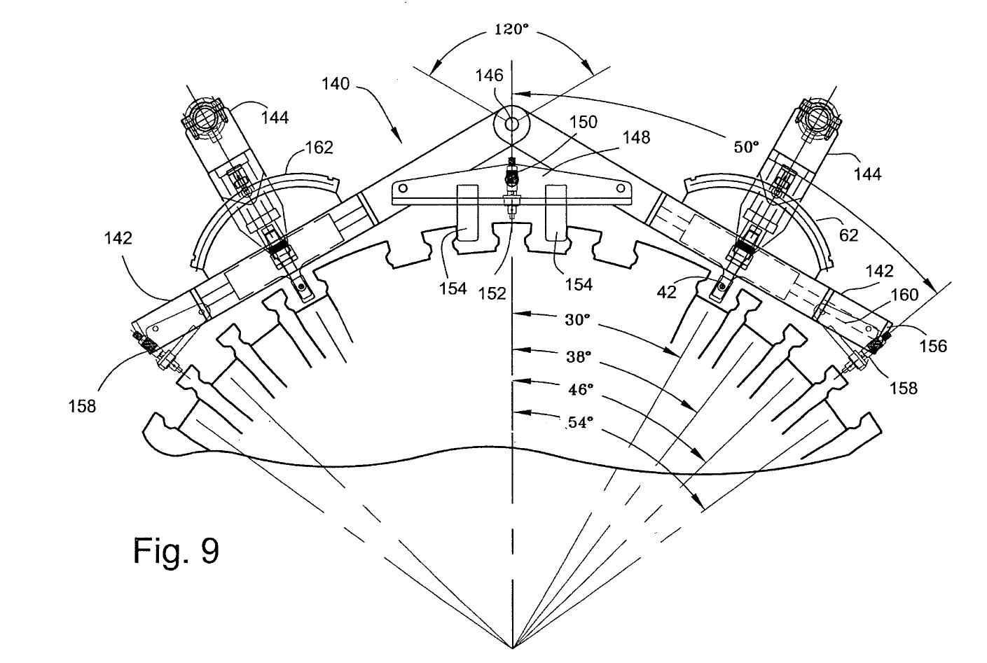

FIG. 9 shows an alternative tooth cutting mechanism to the cutter 140. FIG. 9 shows in partial cross-section, a rotor on which is mounted a cutting frame 140 having a pair of opposite arms 142 which support respective cutting assemblies 144. The arms 142 are connected at one end by a pivot joint 146. The arms are supported by a brace 148 that is attached at its opposite ends to each of the respective arms 142. The brace 148 fixes the angle between the two arms, for example at 120 degrees. The brace includes a micrometer depth gauge 150 that positions the brace and arms 142 above the rotor surface. The micrometer depth gauge 150 accurately and precisely determines the height above a center location 152 on the rotor surface e.g., rotor pole, for the brace 148 and the arm pivot point 146. By adjusting the micrometer depth gauge 150, a machinist can accurately position the pivot point and hence the cutting assemblies 144 above the rotor surface. The brace 148 also includes adjustable positioning blocks 154 to align the brace and arms 142 circumferentially on the rotor. The blocks 154 slide equidistantly away from the center of the template which is aligned with the microdrive. The blocks extend radially inward into a slot 10 beneath the brace. The blocks align the brace and the arms 142 circumferentially with respect to the rotor 14. The positioning of the blocks on the brace 148 is set such that the blocks 154 abut against the side surfaces of their respective rotor slots.

Opposite ends 156 of the arms 142 have respective micrometer depth gauges 158. These micrometer depth gauges 158 position the end 156 of the arm 142 above the surface of the rotor. Normally, the arms 142 will each be positioned an equal distant height above the rotor surface during cutting operation. In the micrometer depth gauge is mounted to the end 156 by an arm by a triangular bracket 160.

The cutting tool frame 140 formed by the arms 142, brace 148 and micrometer depth gauges 150, 158 provide a platform which supports the cutting heads 144 as they are aligned with a slot 10 and in particular, a crack in a slot. The cutting assemblies may provide reciprocal, pivoting and transverse movement to the cutting bit 42, similar to the cutting assembly 52, fan bracket 62 and frame 71 shown in FIG. 4. The frame 140 may be secured to the rotor by straps that fit around the rotor. The frame 140 may be moved axially along the length of the rotor to position one or more of the cutting heads 144 adjacent a crack in a slot.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A machine cutting tool comprising:
a cutting bit positionable in a slot;
a drive shaft rotatably driving the bit;
a cutting assembly slidably supports the bit and drive shaft such that the bit moves reciprocally with respect to the assembly;
a bracket supporting the cutting assembly at a plurality of angular positions, wherein cutting assembly pivots with respect to the bracket about a pivot point proximate to the bit, and
a frame supporting the bracket wherein the frame is slidably attached to the bracket.

2. A machine cutting tool as in claim 1 wherein the slot is a slot in a rotor of a generator.

3. A machine cutting tool as in claim 1 wherein the pivot point is aligned with a center position of the bit.

4. A machine cutting tool as in claim 1 wherein the drive shaft moves reciprocally within a drive shaft housing of the assembly.

5. The machine cutting tool as in claim 1 wherein the frame further comprises at least one rail on which the bracket is slidably mounted.

6. The machine cutting tool as in claim 5 wherein the at least one rail is parallel to the slot.

7. The machine cutting tool as in claim 1 wherein the bracket further comprises a base slidably attached to the frame and a fan bracket slidably attached to the base, wherein the fan bracket slides with respect to the base in a direction perpendicular to the slot.

8. The machine cutting tool as in claim 1 wherein the frame further comprises feet which seat in the slot.

9. The machine cutting tool as in claim 1 wherein the frame further comprises a pair of rails supporting base of the bracket.

10. The machine cutting tool as in claim 1 wherein the bit pivots in two orthogonal directions with respect to the frame.

11. A machine cutting tool comprising:
a cutting bit positionable in a slot of a machine;
a bracket having a plurality of angular positions for supporting and pivoting the bit, wherein bit pivots about a pivot point on the bracket proximate to the bit, and
a frame supporting the bracket on a slidable support providing linear movement to the bit in a plane parallel a pivoting plane of the bit.

12. The machine cutting tool as in claim 11 wherein the machine is a rotor of a generator.

13. The machine cutting tool as in claim 11 wherein the pivot point is aligned with a center position of the bit.

14. The machine cutting tool as in claim 11 wherein the bit moves along a bit centerline with respect to the bracket.

15. The machine cutting tool as in claim 11 wherein the slidable attachment provides movement to the bit in a plane parallel to a pivoting plane of the bit.

16. The machine cutting tool as in claim 11 wherein the bracket slides along the frame to provide movement to the bit in a plane parallel to the slot.

17. A method for machining a crack in a slot defined by opposite teeth, said method comprising:
a. mounting a cutter in said slot such that the cutter is axially aligned with the slot;
b. aligning a cutting bit of the cutter with a section of the opposite teeth to be machined;
c. aligning the cutting bit with a radial line of the slot;
d. moving the cutting bit along a linear path transverse to a slot axis to engage a first tooth of the opposite teeth;
e. machining a radial relief cut in said first tooth;
f. moving the cutting bit along said linear path to a second sooth of the opposite teeth;
g. machining a second radial relief cut in said second tooth;
h. pivoting the cutting bit in a plane parallel to the linear path to a first oblique angle;
i. moving the cutting bit along said linear path to the first tooth;
j. machining a first oblique relief cut in said first tooth;
k. pivoting the cutting bit in said plane to a second oblique angle;
l. moving the cutting bit along said linear path to the second tooth, and
m. machining a second oblique relief cut in said second tooth.

18. A method as in claim 17 wherein the slot is a slot in a rotor of a generator.

19. A method as in claim 17 wherein steps (a) to (m) are preformed sequentially.

20. The method as in claim 17 wherein steps (c) through (m) are preformed while the cutter is mounted at one location in the slot.

21. The method as in claim 17 wherein steps (a) to (m) are repeated at another slot.

22. The method as in claim 17 further comprising identifying a crack in a slot and performing steps (a) to (m) in the slot with the crack.

23. The method as in claim 17 further comprising confirming that a crack in the slot had been removed after step (m).
